(19) United States
(12) Patent Application Publication
(10) Pub. No.: US 2008/0024072 A1
(43) Pub. Date: Jan. 31, 2008

(54) Acoustic resonance free driving electronic ballast for high intensity discharge lamp

(76) Inventor: Chien-Chih Chen, Sinhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/493,551

(22) Filed: Jul. 27, 2006

(51) Int. Cl. H05B 41/36

(52) U.S. Cl. 315/224

(57) ABSTRACT

Acoustic resonance free driving electronic ballast is used in a high intensity discharge lamp, which will prevent acoustic resonance occurred in the lamp, and includes an EMI filter, a line rectifier, and a high-frequency inverter. In use, a voltage is outputted through the line filter, which won't have to pass through large capacitors used for filtering, and which will be supplied through the high-frequency inverter to drive a lamp tube; therefore, the lamp tube has double utility AC line frequency ingredients, which can prevent acoustic resonance. Moreover, if high frequency inverter adopts self-excited driving method, the frequency of inverter varies with input voltage so acoustic resonance can be eliminated. To achieve high power factor, line conditioner with voltage ratio regulation can be adopted to cascade between line rectifier and high frequency inverter. A line conditioner with voltage ratio regulation for making an average current of a first rectified sinusoidal waveform with double utility frequency follow a phase position of rectified sinusoidal voltage waveform with double utility frequency. The present invention can avoid acoustic resonance and increase reliability of whole circuit.

### BACKGROUND OF THE INVENTION

1. Field of the invention

The present invention relates to an acoustic resonance free driving electronic ballast for high intensity discharge lamp, more particularly one, which can prevent acoustic resonance in a lamp tube effectively, help increase life of the circuit, and reduce the cost of the circuit, being capable of performing relatively well.

2. Brief Description of the Prior Art

Power consumed for the purpose of illumination accounts for 15 to 20% of the total. People are developing high-efficient and pollution free light sources to replace low-efficient and potentially polluting ones in light of environmental pollution and energy shortage.

High intensity discharge (HID) lamps are among the high-efficient and pollution free light sources, which are high-efficient, and have excellent color-reproduction ability, long life, and low light decay. High intensity discharge lamps are highly efficient because their radiant energy output contains higher proportion of visible light than other kinds of light sources. High intensity discharge lamps are getting more popular, widely used in many different places such as stadiums, roads, bridges, malls, homes, and in many different applications such as lithograph plates of printing, optical fiber engines, TV with high image resolution, LCD projectors, and car headlamps.

Conventional high intensity discharge lamps are only suitable for outdoor use because they produce light of many lumens. In recent years, more attention and resource have been given to research and development of low-power high intensity discharge lamps, which are usually used as the light sources of entertaining equipments (projection TV) and car lamps. However, because low frequency (60 Hz) inductors, which are low-efficient, large in size, and heavy in weight, are used as the ballasts conventionally, there are many limitations in the use of HID lamps.

Referring to FIGS. 20 and 21, a high intensity discharge lamp can be powered with direct current or alternating current in stability condition. The electrode on one end of the high intensity discharge lamp will become old more rapidly through use under a direct-current mode, and in turn life of the lamp is reduced. Therefore, high intensity discharge lamps are usually powered with alternating current; thus, currents passing through the electrodes of two ends of the lamp will change in the direction, and the electrodes of two ends will become old more slowly at the same speed, and the service life of the lamp will be longer.

However, gas will vibrate in the discharge lamp tube owing to the cyclically changing power supplied to the discharge lamp tube; when the frequency of the cyclically changing power approximates to the resonant frequency of the lamp tube, it will cause gas pressure wave to vibrate forwards and backwards in the lamp tube. After several cycles, the gas pressure wave emitted from the electrodes and reflected from the inner side of the lamp tube will resonate and with an even greater amplitude. Consequently, the discharge path will be distorted owing to the strong gas wave in the lamp tube; such a phenomenon is called acoustic resonance, which results in instability of arc-light discharge, flashing of output, and deterioration of light output quality. Therefore, it is important to avoid acoustic resonance in lamp tubes.

### SUMMARY OF THE INVENTION

It is a main object of the invention to provide an improvement on electronic ballast to high intensity discharge lamps, which will prevent acoustic resonance occurred in the lamp. Acoustic resonance free driving electronic ballast of the present invention includes an EMI filter, a line rectifier, and a high-frequency inverter. In use, a voltage is outputted through the line filter, which won't have to pass through large capacitors used for filtering, and which will be supplied through the high-frequency inverter to drive a lamp tube; therefore, the lamp tube has double utility AC line frequency ingredients, which can prevent acoustic resonance. Moreover, if high frequency inverter adopts self-excited driving method, the frequency of inverter varies with input voltage so acoustic resonance can be eliminated. To achieve high power factor, line conditioner with voltage ratio regulation can be cascaded between line rectifier and high frequency inverter. A line conditioner with voltage ratio regulation for making an average current of a first rectified sinusoidal waveform with double utility frequency follow a phase position of rectified sinusoidal voltage waveform with double utility frequency. The present invention can avoid acoustic resonance and increase reliability of whole circuit.

### BRIEF DESCRIPTION OF THE DRAWINGS

The present invention will be better understood by referring to the accompanying drawings, wherein:

FIG. 1 is a view showing the structure of the control circuit of the first preferred embodiment in the present invention,

FIG. 2 is a view showing the structure of the control circuit of the second preferred embodiment,

FIG. 3 is a view showing comparison between input and output voltages of the line conditioner with voltage ratio regulation in the present invention,

FIG. 4 is a view showing comparison between input and output voltages of the line conditioner with voltage ratio regulation in the present invention,

FIG. 5 is a view showing comparison between input and output voltages of the line conditioner with voltage ratio regulation in the present invention,

FIG. 6 is a view showing comparison between input and output voltages of the line conditioner with voltage ratio regulation in the present invention,

FIG. 7 is a view of the half-bridge type high frequency inverter in the present invention,

FIG. 8 is a view of the half-bridge type high frequency inverter in the present invention,

FIG. 9 is a view of the full-bridge type high frequency inverter in the present invention,

FIG. 10 is a view of the push-pull hybrid type high frequency inverter in the present invention,

FIG. 11 is a view of a first self-excited type high frequency inverter in the present invention,

FIG. 12 is a view of the first self-excited type high frequency inverter in the present invention,

FIG. 13 is a view of another self-excited type high frequency inverter in the present invention,

FIG. 14 is a view of another self-excited type high frequency inverter in the present invention,

FIG. 15 is a view showing input voltage, driving frequency and lamp tube current of self-excited driving inverter with a direct current offset,

FIG. 16 is a view showing input voltage, driving frequency and lamp tube current of self-excited driving inverter without a direct current offset,

FIG. 17 is a view showing the structure of the circuit with a lamp power monitor for modulating the frequency of the high-frequency inverter in the first preferred embodiment,

FIG. 18 is a view showing the structure of the circuit with a lamp power monitor for modulating the frequency of the high-frequency inverter in the second preferred embodiment

FIG. 19 is a view showing the structure of the circuit with a lamp power monitor for modulating the second rectified sinusoidal waveform with double utility frequency,

FIG. 20 is a view of the currently existing direct current activated high intensity discharge lamp, and

FIG. 21 is a view of the currently existing alternating current activated high intensity discharge lamp.

### DETAILED DESCRIPTION OF THE PREFERRED EMBODIMENTS

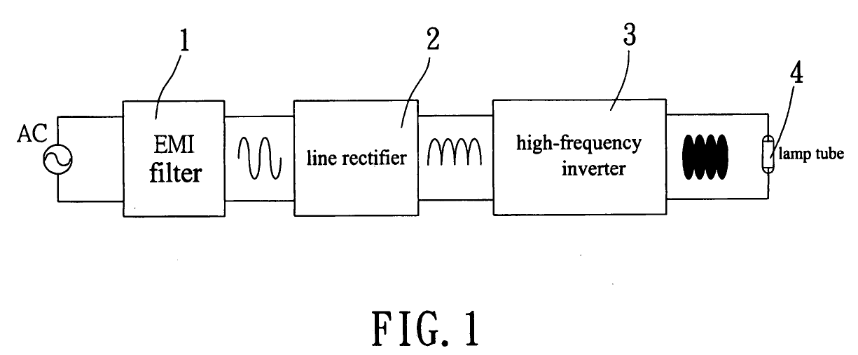

Referring to FIG. 1, a preferred embodiment of an acoustic resonance free driving electronic ballast for a high intensity discharge lamp includes an EMI filter 1, a line rectifier 2, and a high-frequency inverter 3.

The EMI filter 1 is used for reducing electromagnetic interference. The line rectifier 2 is used for rectifying and transforming utility AC line voltage into a first rectified sinusoidal waveform with double utility frequency as well as outputting a first direct current electricity. The high-frequency inverter 3 is used for converting the first rectified sinusoidal waveform into a high-frequency alternating current, which is supplied to a lamp tube 4 immediately after.

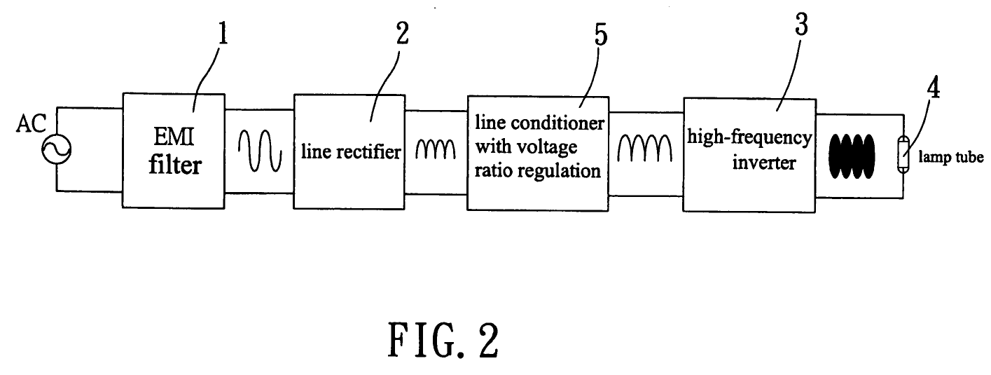

Referring to FIG. 2, the present invention further has a line conditioner with voltage ratio regulation 5 be adopted and cascaded between the line rectifier 2 and the high-frequency inverter 3 for achieving high power factor. The line conditioner with voltage ratio regulation 5 is used for making the average current of input of the first rectified sinusoidal waveform with double utility frequency follow the phase position of first rectified sinusoidal waveform with double utility frequency, transforming the first rectified sinusoidal waveform with double utility frequency into a second rectified sinusoidal waveform with double utility frequency as well as outputting the second pulse direct current voltage.

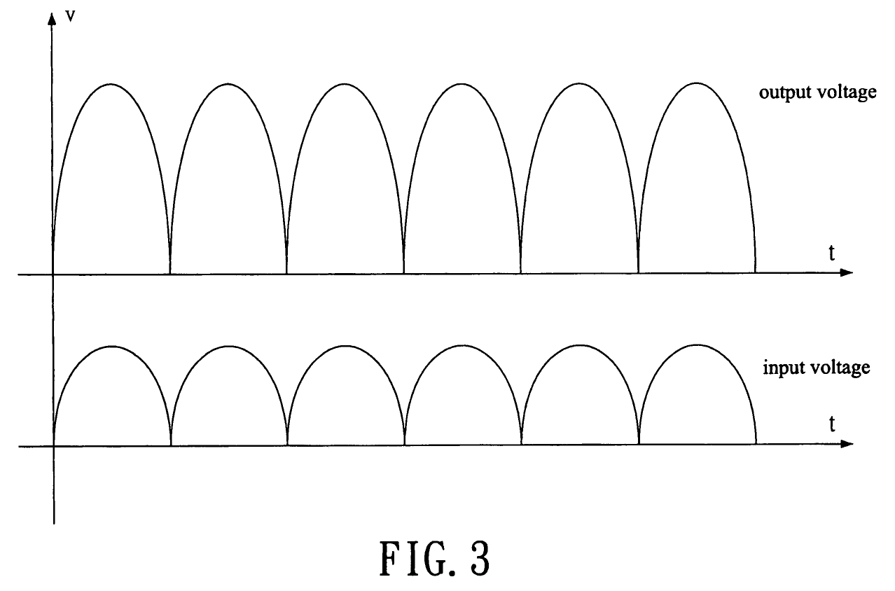

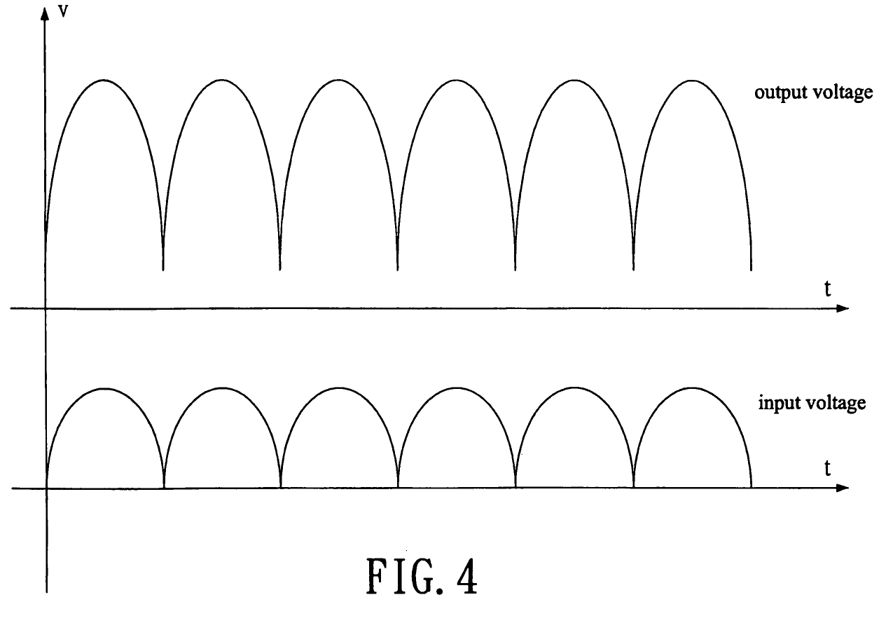

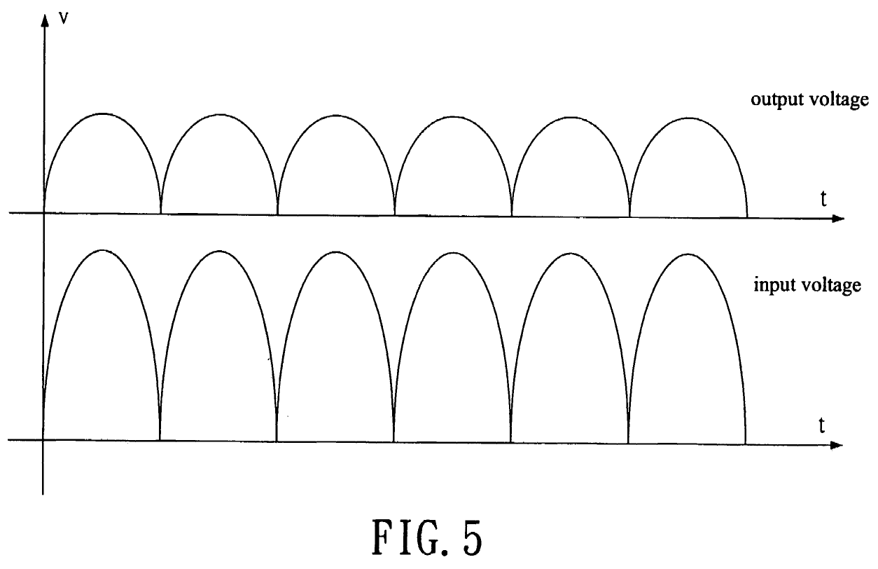

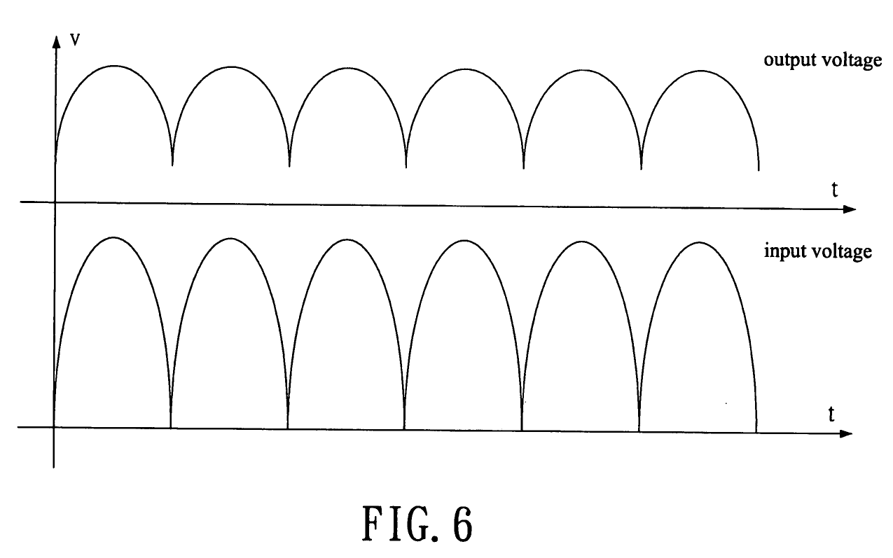

Therefore, referring to FIGS. 3 to 6, there is no need for high-capacitance electrolyzing capacitors used for filtering, the life of the ballast is increased, and the cost of the ballast reduced. Furthermore, the first rectified sinusoidal waveform has double utility frequency alternating current ingredients, and is converted into a high-frequency alternating current through the high-frequency inverter 3 for driving the high intensity discharge lamp tube 4 therefore the lamp tube 4 has double utility AC line frequency ingredients, which can prevent acoustic resonance. Moreover, if high frequency inverter 3 adopts self-excited driving method, the frequency of inverter varies with input voltage so acoustic resonance can be eliminated. Consequently, acoustic resonance problem can be avoided, and the stability of the system increases.

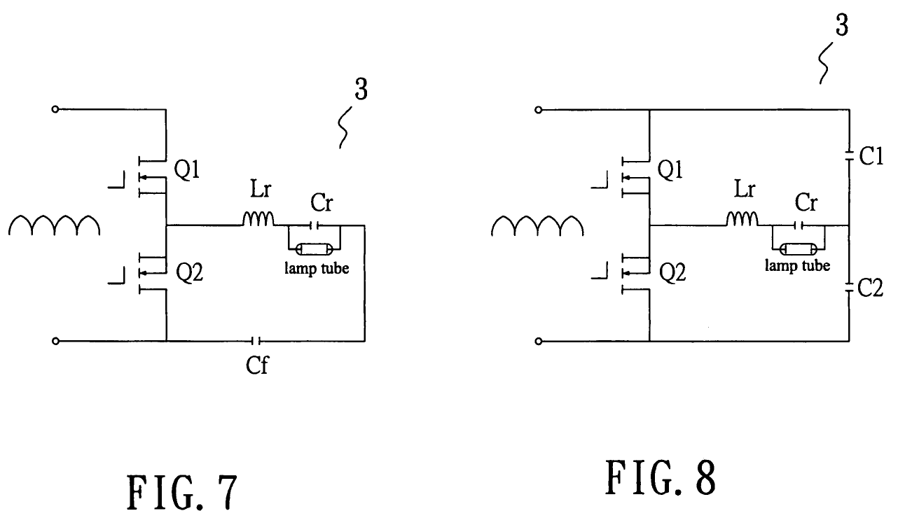

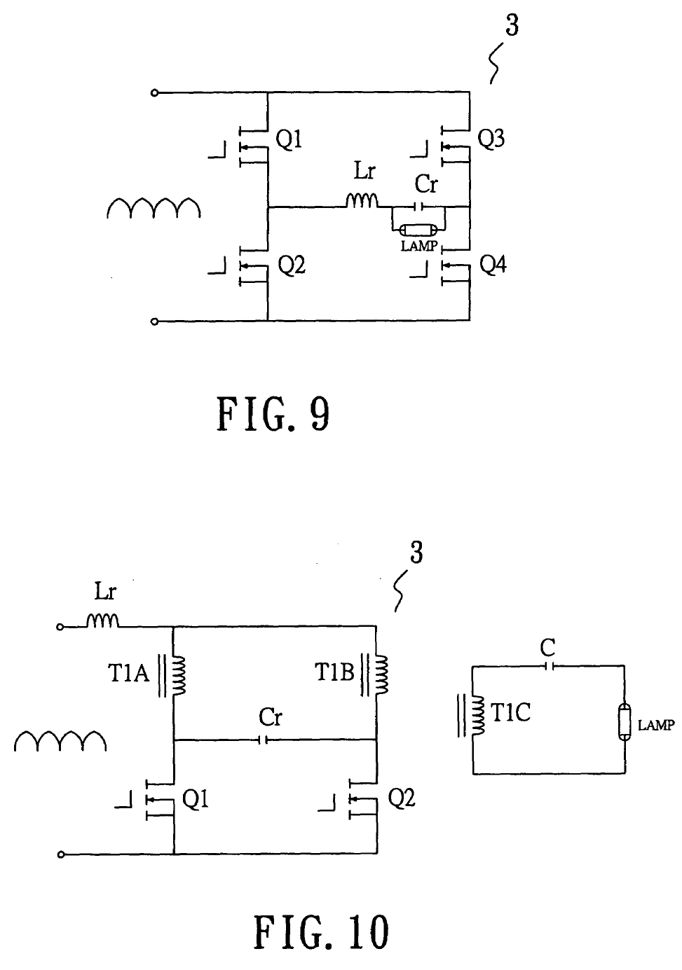

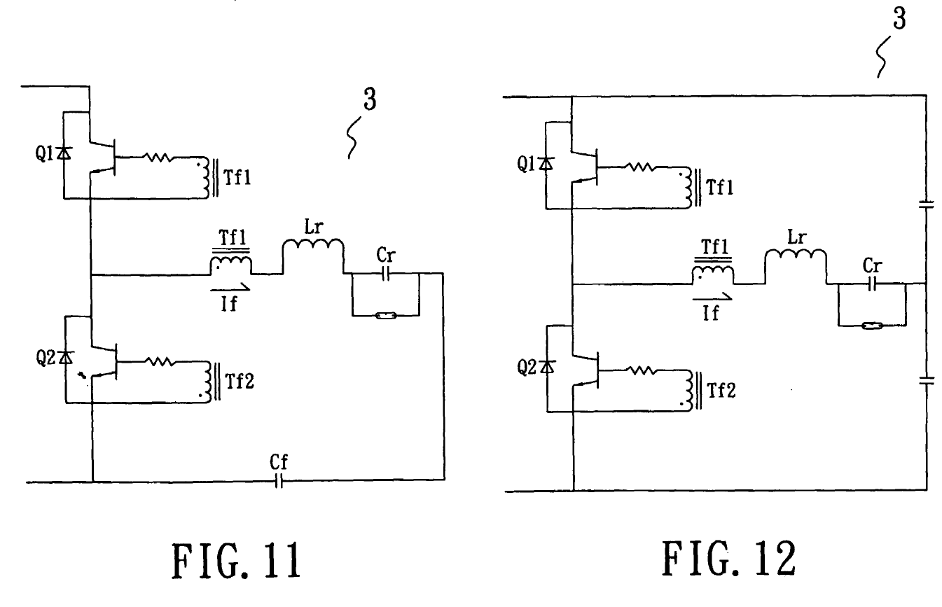

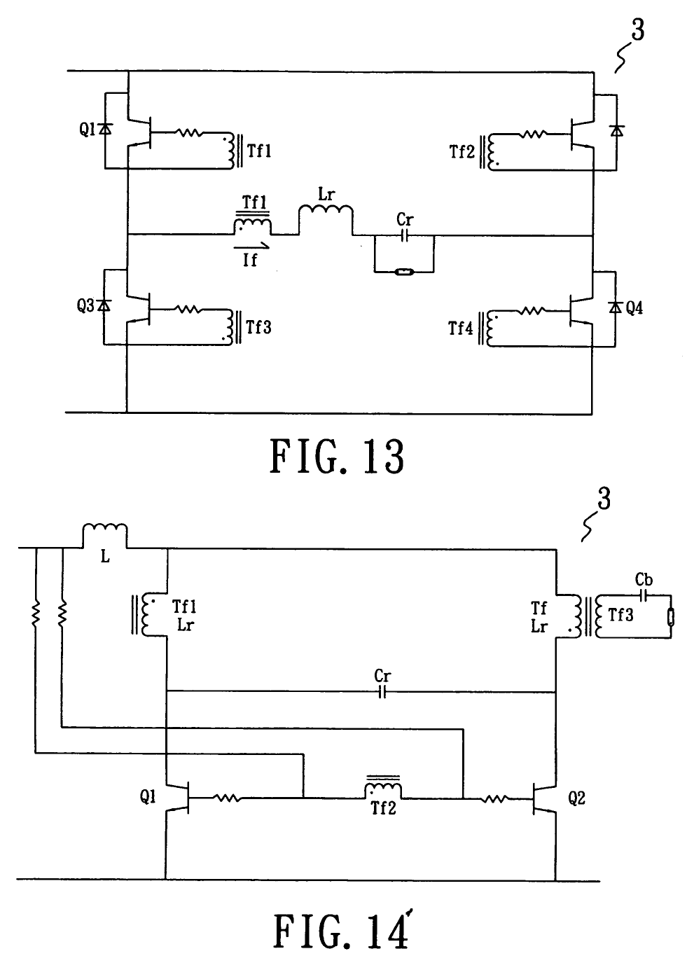

The high-frequency inverter 3 can be of a half-bridge type (as shown in FIGS. 7 and 8), full-bridge type (as shown in FIG. 9) or push pull hybrid type (as shown in FIG. 10). The high-frequency inverter 3 can be of a self-excited half-bridge type, as shown in FIGS. 11 and 12, wherein Tf, Tf1, and Tf2 are multiple winding of transformer; during operating, an current will pass through Tf, and induce driving signals at Tf1 and Tf2 to drive switches Q1 and Q2 alternately. The high-frequency inverter 3 can be of a self-excited full-bridge type as shown in FIG. 13, wherein Tf, Tf1, Tf2, Tf3, and Tf4 are multiple winding of transformer; during operating, an current will pass through Tf, and induce driving signals at Tf1, Tf2, Tf3, and Tf4 to drive switches Q1, Q2, Q3, and Q4 alternately. The high-frequency inverter 3 can be of a self-excited push-pull hybrid type as shown in FIG. 14, wherein L will transform voltage source into current source, and Tf, Tf1, Tf2, and Tf3 are multiple winding of transformer; during operating, an current will pass through Tf and Tf1, and induce a driving signal at Tf2 to drive switches Q1 and Q2 alternately, and pass through Tf3 to drive the lamp tube.

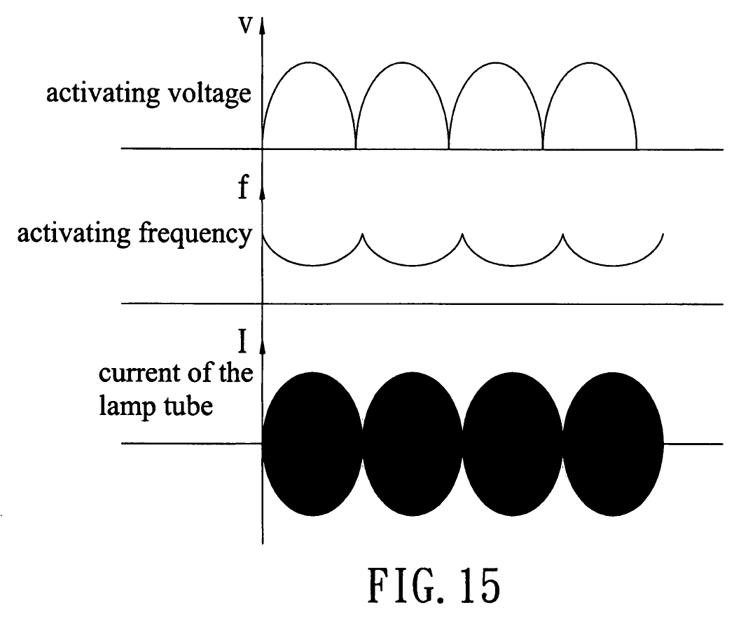

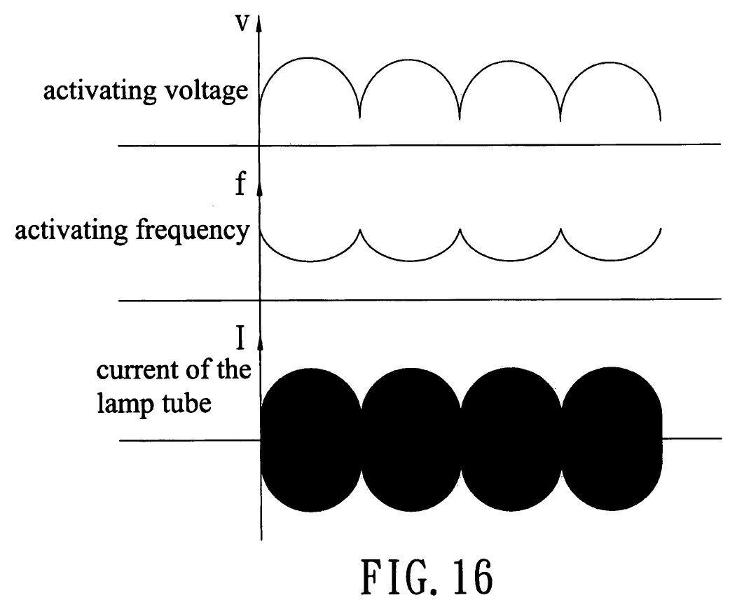

FIGS. 15 and 16 shown the wave shape realized by the present invention, wherein “offset sinusoid voltage” means the input rectified sinusoidal voltage of inverter 3, and has a direct current voltage offset, as shown in FIG. 15, or without direct current voltage offset, as shown in FIG. 15. Adopting self-excited driving method, the operating frequency of the self-excited driving inverter 3 will vary with the activating voltage. And, the amplitude and frequency of the current of the lamp tube 4 will also vary with the driving voltage.

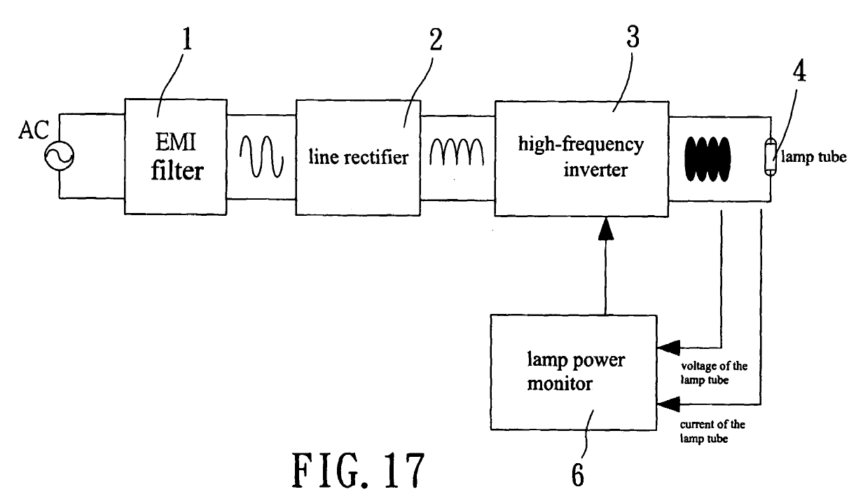

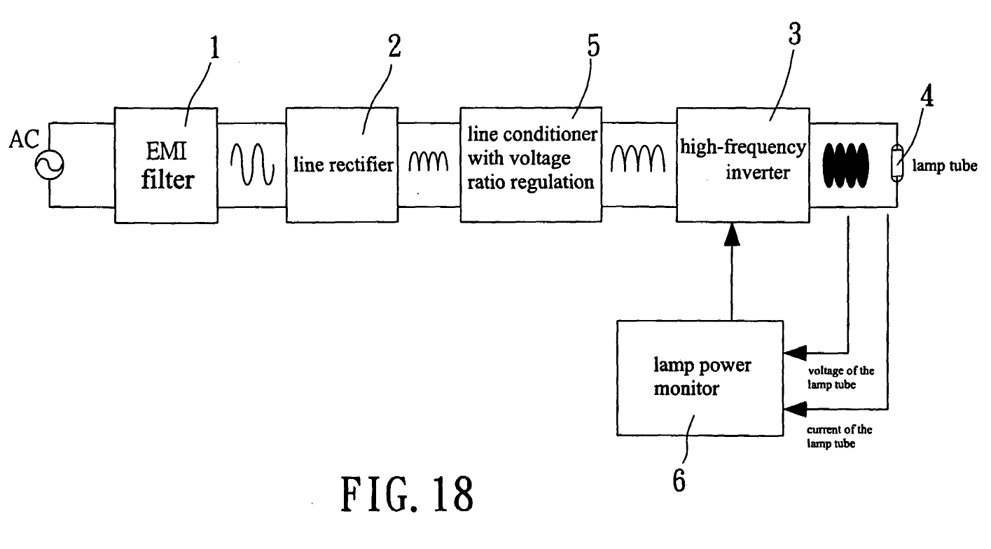

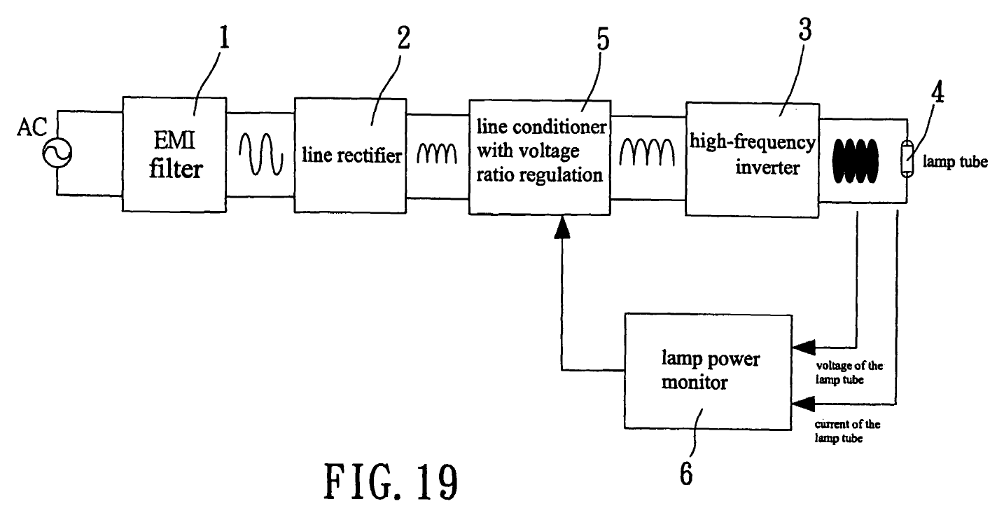

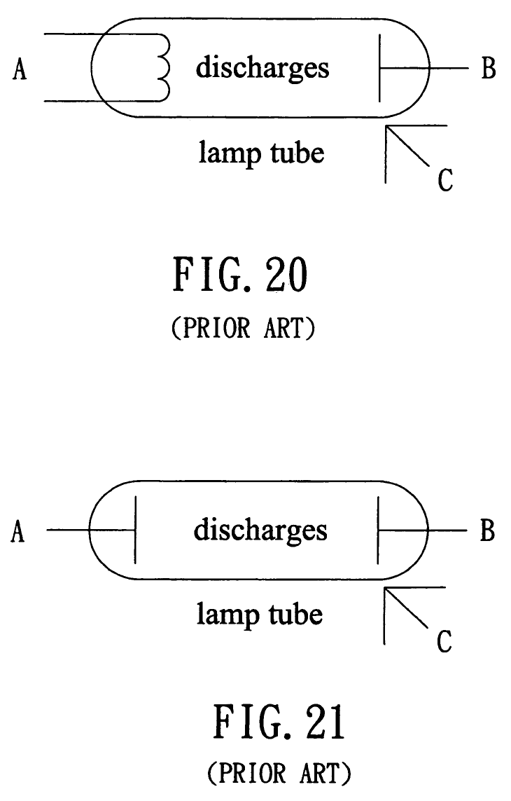

Referring to FIGS. 17 and 18, the present invention can be further equipped with a lamp power monitor 6 interposed between and connected to the lamp tube 4 and the high-frequency inverter 3 for detecting the current or power of the lamp tube 4 and modulating the frequency of the high-frequency inverter 3 such that the lamp tube 4 has constant current or constant power. Or alternatively, referring to FIG. 19, the present invention can be further equipped with a lamp power monitor 6 interposed between and connected to the lamp tube 4 and the line conditioner with voltage ratio regulation 5 for detecting the current or power of the lamp tube 4 and modulating the amplitude of second rectified sinusoidal waveform with double utility frequency such that the lamp tube 4 has constant current or constant power.

From the above description, it can be seen that the present invention has the following advantages over the prior art: in the present invention, the line rectifier is used for producing rectified sinusoidal waveform with double utility frequency, and supplied to the high-frequency inverter to drive the high intensity discharge lamp. Therefore, the lamp tube has double utility AC line frequency ingredients, which can prevent acoustic resonance. Moreover, if high frequency inverter adopts self-excited driving method, the frequency of inverter varies with input voltage, so acoustic resonance can be eliminated. To achieve high power factor, line conditioner with voltage ratio regulation can be adopted to cascade between line rectifier and high frequency inverter. A line conditioner with voltage ratio regulation for making an average current of a first rectified sinusoidal waveform with double utility frequency follow a phase position of rectified sinusoidal voltage waveform with double utility frequency. The present invention can avoid acoustic resonance and increase reliability of whole circuit.

What is claimed is:

1. An acoustic resonance free driving electronic ballast for high intensity discharge lamps, comprising
An EMI filter for reducing electromagnetic interference;
a line rectifier for rectifying and transforming utility AC line voltage to be a first rectified sinusoidal waveform with double utility frequency as well as outputting a first direct current electricity; and
a high-frequency inverter is used to convert said first rectified sinusoidal waveform with double utility frequency into high-frequency alternating current, which is then supplied to a lamp tube.

2. The acoustic resonance free driving electronic ballast for high intensity discharge lamp as recited in claim 1, wherein said high-frequency inverter is of a half-bridge type.

3. The acoustic resonance free driving electronic ballast for high intensity discharge lamp as recited in claim 1, wherein said high-frequency inverter is of a full-bridge type.

4. The acoustic resonance free driving electronic ballast for high intensity discharge lamp as recited in claim 1, wherein said high-frequency inverter is of a push-pull hybrid type.

5. The acoustic resonance free driving electronic ballast for high intensity discharge lamp as recited in claim 1, wherein said high-frequency inverter is of a self-excited half-bridge type.

6. The acoustic resonance free driving electronic ballast for high intensity discharge lamp as recited in claim 1, wherein said high-frequency inverter is of a self-excited full-bridge type.

7. The acoustic resonance free driving electronic ballast for high intensity discharge lamp as recited in claim 1, wherein said high-frequency inverter is of a self-excited push-pull hybrid type.

8. The acoustic resonance free driving electronic ballast for high intensity discharge lamp as recited in claim 1, wherein a lamp power monitor is interposed between and connected to said lamp tube and said high-frequency inverter for detecting electric current and electric power of said lamp tube and modulating frequency of said high-frequency inverter such that said lamp tube has constant current or constant power.

9. An acoustic resonance free driving electronic ballast for high intensity discharge lamps, comprising
an EMI filter for reducing electromagnetic interference;;
a line rectifier for rectifying and transforming utility AC line voltage to be a first rectified sinusoidal waveform with double utility frequency as well as outputting a first direct current electricity; and
a line conditioner with voltage ratio regulation for making an average current of a first rectified sinusoidal waveform with double utility frequency follow a phase position of rectified sinusoidal waveform with double utility frequency, transforming said first rectified sinusoidal waveform with double utility frequency into a second rectified sinusoidal waveform with double utility frequency as well as outputting said second pulse direct current voltage; and
a high-frequency inverter for converting said second rectified sinusoidal waveform with double utility frequency into high-frequency alternating current, which is then supplied to a lamp tube.

10. The acoustic resonance free driving electronic ballast for high intensity discharge lamp as recited in claim 9, wherein said high-frequency inverter is of a half-bridge type.

11. The acoustic resonance free driving electronic ballast for high intensity discharge lamp as recited in claim 9, wherein said high-frequency inverter is of a full-bridge type.

12. The acoustic resonance free driving electronic ballast for high intensity discharge lamp as recited in claim 9, wherein said high-frequency inverter is of a push-pull hybrid type.

13. The acoustic resonance free driving electronic ballast for high intensity discharge lamp as recited in claim 9, wherein said high-frequency inverter is of a self-excited half-bridge type.

14. The acoustic resonance free driving electronic ballast for high intensity discharge lamp as recited in claim 9, wherein said high-frequency inverter is of a self-excited full-bridge type.

15. The acoustic resonance free driving electronic ballast for high intensity discharge lamp as recited in claim 9, wherein said high-frequency inverter is of a self-excited push-pull hybrid type.

16. The acoustic resonance free driving electronic ballast for high intensity discharge lamp as recited in claim 9, wherein a power detecting circuit is interposed between and connected to said lamp tube and said line conditioner with voltage ratio regulation for detecting current and power of said lamp tube and modulating said second rectified sinusoidal waveform with double utility frequency such that said lamp tube has constant current or constant power.
